(19) United States
(12) Patent Application Publication
(10) Pub. No.: US 2018/0348779 A1
(43) Pub. Date: Dec. 6, 2018

(54) VEHICLE CONTROL SYSTEM, VEHICLE CONTROL METHOD, AND STORAGE MEDIUM

(71) Applicant: HONDA MOTOR CO., LTD., Tokyo (JP)

(72) Inventor: Yoshihiro Oniwa, Wako-shi (JP)

(21) Appl. No.: 15/990,873

(22) Filed: May 29, 2018

(30) Foreign Application Priority Data
Jun. 1, 2017 (JP) 2017-109271

(51) Int. Cl. G05D 1/02; B62D 6/10; B60W 30/12

(52) U.S. Cl. CPC G05D 1/0234; B62D 6/10; B60W 2420/42; G05D 1/0223; B60W 30/12

(57) ABSTRACT

A vehicle control system includes a recognition unit that recognizes lane markers on a road; and a steering control unit that performs first steering control so that a subject vehicle does not deviate from a traveling lane on which the subject vehicle travels on the basis of a lane marker demarcating the traveling lane among the lane markers recognized by the recognition unit, and when a lane marker demarcating the traveling lane is not recognized by the recognition unit in front of the subject vehicle or when an index value indicating a degree of recognition of the lane marker is smaller than a threshold value, the steering control unit limits the first steering control, determines a target steering angle in a range of predetermined angles with reference to a steering angle at the time of traveling in a straight line of the subject vehicle, and performs second steering control at the determined target steering angle.

### CROSS-REFERENCE TO RELATED APPLICATION

This application is based upon and claims the benefit of priority from Japanese Patent Application No. 2017-109271, filed on Jun. 1, 2017, the entire contents of which are incorporated herein by reference.

### BACKGROUND OF THE INVENTION

### Field of the Invention

The present invention relates to a vehicle control system, a vehicle control method, and a storage medium.

### Description of Related Art

In the related art, a technique of automatically controlling a distance between a subject vehicle and an adjacent vehicle so that the distance is kept at a predetermined minimum distance when lane information is not available or not reliable is known (for example, Published Japanese Translation No. 2015-523256 of the PCT International Publication)).

### SUMMARY OF THE INVENTION

However, according to the related art, when the lane information cannot be acquired and there is no other vehicle on an adjacent lane, it is difficult to continue the control. Therefore, there is a case in which the control is ended and switching to manual driving is performed. When switching to manual driving is performed, a steering torque is not applied to a steering wheel. Accordingly, an occupant gripping the steering wheel may feel unease.

Aspects of the present invention have been made in view of such circumstances, and an object thereof is to provide a vehicle control system, a vehicle control method, and a storage medium capable of switching control more naturally.

A vehicle control system, a vehicle control method, and a storage medium according to the present invention adopt the following configuration.

(1) An aspect of the present invention is a vehicle control system, including: a recognition unit that recognizes lane markers on a road; and a steering control unit that performs first steering control so that a subject vehicle does not deviate from a traveling lane on which the subject vehicle is traveling on the basis of lane markers demarcating the traveling lane among the lane markers recognized by the recognition unit, wherein when a lane marker demarcating the traveling lane is not recognized by the recognition unit in front of the subject vehicle or when an index value indicating a degree of recognition of the lane markers is smaller than a threshold value, the steering control unit, limits the first steering control, determines a target steering angle in a range of predetermined angles with reference to a steering angle at the time of traveling in a straight line of the subject vehicle, and performs second steering control at the determined target steering angle.

(2) In the vehicle control system according to the aspect (1), when return from a state in which a lane marker demarcating the traveling lane is not recognized to a state in which the lane marker is recognized occurs or when return from a state in which the index value is smaller than the threshold value to a state in which the index value is equal to or greater than the threshold value occurs, the steering control unit limits the second steering control and perform the first steering control.

(3) In the vehicle control system according to the aspect (1), the steering control unit may perform the second steering control when the subject vehicle is traveling on an expressway.

(4) The vehicle control system according to the aspect (1) further includes an operation detection unit that detects that a driving operator is being operated by an occupant of the subject vehicle, and the steering control unit performs the second steering control when an operation of the driving operator is detected by the operation detection unit.

(5) The vehicle control system according to the aspect (4) further includes a report unit that reports predetermined information for requesting an occupant of the subject vehicle to operate the driving operator when a lane marker demarcating the traveling lane is not recognized in front of the subject vehicle by the recognition unit or when the index value is smaller than the threshold value, and the steering control unit continues the second steering control until a predetermined time elapses after the report unit reports the predetermined information, and limits the second steering control when the operation of the driving operator is not detected within a predetermined time by the operation detection unit.

(6) The vehicle control system according to the aspect (1) further includes a speed control unit that performs deceleration control for decelerating the subject vehicle when the second steering control is limited by the steering control unit,

(7) The vehicle control system according to the aspect (1) further includes an automatic driving control unit that performs automatic driving control for automatically controlling steering and acceleration or deceleration of the subject vehicle, and the automatic driving control unit performs the automatic driving control in which it is not required that a driving operator is gripped by an occupant of the subject vehicle when the lane marker demarcating the traveling lane is recognized by the recognition unit or when the index value is equal to or greater than the threshold value, and limits the automatic driving control and causes the steering control unit to perform the second steering control when the lane marker demarcating the traveling lane is not recognized by the recognition unit or when the index value is smaller than the threshold value.

(8) The vehicle control system according to the aspect (1) further includes an operation detection unit that detects that a driving operator is operated by an occupant of the subject vehicle; and an automatic driving control unit that performs automatic driving control for automatically controlling steering and acceleration or deceleration of the subject vehicle, and the automatic driving control unit performs the automatic driving control in which it is not required that a driving operator is gripped by an occupant of the subject vehicle when the lane marker demarcating the traveling lane is recognized by the recognition unit or when the index value is equal to or greater than the threshold value, and performs automatic driving control in which it is required that the driving operator is gripped by the occupant of the subject vehicle when the lane marker demarcating the traveling lane is not recognized by the recognition unit or when the index value is smaller than the threshold value, and when the operation of the driving operator is not detected by the operation detection unit.

(9) Another aspect of the present invention is a vehicle control system, including: a recognition unit that recognizes lane markers on a road; a generation unit that generates a target trajectory on the basis of a lane marker demarcating a traveling lane on which a subject vehicle travels among the lane markers recognized by the recognition unit; and a steering control unit that determines a target steering angle on the basis of a curvature of the target trajectory generated by the generation unit and performs steering control on the basis of the determined target steering angle, wherein the generation unit determines the curvature of the target trajectory on the basis of a predetermined angle with reference to a steering angle at the time of traveling in a straight line of the vehicle when the lane marker demarcating the lane is not recognized in front of the subject vehicle by the recognition unit or when an index value indicating a degree of recognition of the lane marker is smaller than a threshold value.

(10) In the vehicle control system according to the aspect (1), the steering control unit causes a current steering angle to approach the target steering angle while limiting the amount of change in the steering angle per a predetermined time when the lane marker demarcating the traveling lane is not recognized or when the index value is smaller than the threshold value.

(11) In the vehicle control system according to the aspect (1), when the lane marker demarcating the traveling lane is not recognized or when the index value is smaller than the threshold value, the steering control unit keeps a current steering angle until a predetermined time elapses or until a subject vehicle travels a predetermined distance and causes the current steering angle to approach the target steering angle after the predetermined time elapses or after the subject vehicle travels the predetermined distance.

(12) Another aspect of the present invention is a vehicle control method which is performed by a vehicle-mounted computer, the method including: recognizing lane markers on a road; performing first steering control so that the subject vehicle does not deviate from a traveling lane on which the subject vehicle travels on the basis of a lane marker demarcating the traveling lane among the recognized lane markers; limiting the first steering control and determining a target steering angle in a range of predetermined angles with reference to a steering angle at the time of traveling in a straight line of the subject vehicle when the lane marker demarcating the traveling lane is not recognized in front of the subject vehicle or when an index value indicating a degree of recognition of the lane marker is smaller than a threshold value; and performing second steering control at the determined target steering angle.

(13) Another aspect of the present invention is a storage medium storing a vehicle control program, the vehicle control program causing a vehicle-mounted computer to: recognize lane markers on a road, perform first steering control so that the subject vehicle does not deviate from a traveling lane on which a subject vehicle travels on the basis of a lane marker demarcating the traveling lane among the recognized lane markers, limit the first steering control and determine a target steering angle in a range of predetermined angles with reference to a steering angle at the time of traveling in a straight line of the subject vehicle when the lane marker demarcating the traveling lane is not recognized in front of the subject vehicle or when an index value indicating a degree of recognition of the lane marker is smaller than a threshold value, and perform second steering control at the determined target steering angle.

According to the aspects (1), (9), (12), and (13), it is possible to switch the control more naturally.

According to the aspect (2), it is possible to reduce labor of causing the vehicle to return to a state in which lane keeping control or out-of-road deviation prevention control can be performed, for example, by the occupant operating a dedicated switch or the like.

According to the aspect (3), it is possible to reduce unease of an occupant caused by setting the target steering angle with reference to the steering angle at the time of traveling in a straight line in a straight line.

According to the aspect (4), the occupant can rapidly perform steering, and it is possible to prevent steering control not intended by the occupant from being performed.

According to the aspect (5), since the occupant is requested to operate the steering wheel and the straight travel control (second steering control) is performed until the steering control is performed according to the operation of the steering wheel of the occupant, it is possible to continue the control even when a reliability of the recognized lane marker is smaller than a threshold value.

According to the aspect (6), when the occupant cannot perform the steering control manually or when there is no intention of steering control, it is possible to limit the continuation of vehicle traveling not intended by the occupant.

According to the aspects (7) and (8), it is possible to perform shift to appropriate automatic driving on the basis of a lane detection state and a steering state.

According to the aspect (10), it is possible to curtail a sudden change in the steering angle and reduce unease feeling of the occupant.

According to the aspect (11), it is possible to further extend a time until the subject vehicle moves outside of the traveling lane and to secure sufficient time to detect whether or not the occupant is able to grip the steering wheel.

### BRIEF DESCRIPTION OF THE DRAWINGS

FIG. 1 is a configuration diagram of a vehicle control system according to a first embodiment.

FIG. 2 is a diagram illustrating a state in which a relative position and posture of a subject vehicle M relative to a traveling lane are recognized by a subject-vehicle position recognition unit.

FIG. 3 is a diagram illustrating an example of a scene in which a lane marker is not recognized in the middle of a road.

FIG. 4 is a flowchart illustrating a series of processes in a driving assistance control unit in the first embodiment.

FIG. 5 is a diagram schematically illustrating a state of behavior of the subject vehicle according to second steering control.

FIG. 6 is a diagram illustrating an example of a relationship between a steering angle and elapsed time.

FIG. 7 is a diagram illustrating another example of the relationship between a steering angle and an elapsed time.

FIG. 8 is a configuration diagram of a vehicle control system according to a second embodiment.

FIG. 9 is a diagram illustrating a state in which a target trajectory is generated on the basis of a recommended lane.

FIG. 10 is a flowchart illustrating a series of processes in the automatic driving control unit in the second embodiment.

### DETAILED DESCRIPTION OF THE INVENTION

Hereinafter, embodiments of a vehicle control system, a vehicle control method, and a storage medium according to the present invention will be described with reference to the drawings.

### First Embodiment

### [Overall Configuration]

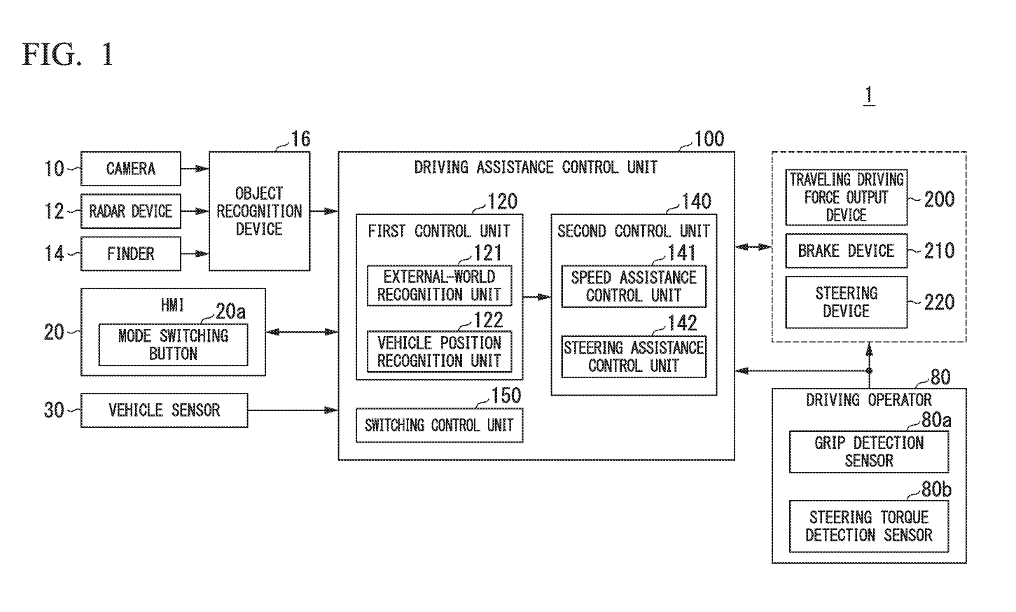

FIG. 1 is a configuration diagram of a vehicle control system 1 according to a first embodiment. A vehicle on which the vehicle control system 1 is mounted (hereinafter referred to as a subject vehicle M) is, for example, a vehicle such as a two-wheeled, three-wheeled, or four-wheeled vehicle. A driving source thereof is an internal combustion engine such as a diesel engine or a gasoline engine, an electric motor, or a combination thereof. The electric motor is operated using power generated by a generator connected to the internal combustion engine, or discharge power of a secondary battery or a fuel cell.

The vehicle control system 1 includes, for example, a camera 10, a radar 12, a finder 14, an object recognition device (object recognizer) 16, a human machine interface (HMI) 20, a vehicle sensor 30, a driving operator 80, a driving assistance control unit (driving assistance controller) 100, a traveling driving force output device (traveling driving force outputter) 200, a brake device 210, and a steering device 220. The apparatuses or devices are connected to each other by a multiplex communication line such as a controller area network (CAN), a serial communication line, a wireless communication network, or the like. The configuration illustrated in FIG. 1 is merely an example, and a part of the configuration may be omitted, or other configurations may be added.

The camera 10 is, for example, a digital camera using a solid-state imaging element such as a charge coupled device (CCD) or a complementary metal oxide semiconductor (CMOS). One or a plurality of cameras 10 are attached to any places on the subject vehicle M. In the case of imaging in front, the camera 10 is attached to an upper portion of a front windshield, a rear back of a compartment mirror, or the like. The camera 10, for example, periodically repeatedly images the surroundings of the subject vehicle M. The camera 10 may be a stereo camera.

The radar 12 radiates radio waves such as millimeter waves to the vicinity the subject vehicle M and detects radio waves (reflected waves) reflected by an object to detect at least a position (distance and orientation) of the object. One or a plurality of radars 12 are attached to any places on the subject vehicle M. The radar 12 may detect a position and a speed of an object using a frequency modulated continuous wave (FM-CW) scheme.

The finder 14 is light detection and ranging, or laser imaging detection and ranging (LIDAR) for measuring scattered light with respect to irradiation light and detects a distance to an object. One or a plurality of finders 14 are attached to any places on the subject vehicle M.

The object recognition device 16 performs a sensor fusion process on detection results of some or all of the camera 10, the radar 12, and the finder 14 to recognize a position, type, speed, movement direction, and the like of an object. The object to be recognized is, for example, a vehicle, or various objects such as a guardrail, a utility pole, a pedestrian, and a road sign. The object recognition device 16 outputs recognition results to the driving assistance control unit 100. The object recognition device 16 may output a part of information input from the camera 10, the radar 12, or the finder 14 to the driving assistance control unit 100 as it is.

The HMI 20 presents various types of information to the occupant of the subject vehicle M and accepts an input operation of the occupant. The HMI 20 includes various display devices such as a liquid crystal display (LCD) and an organic electroluminescence (EL) display, various buttons such as a mode switching button 20a, a speaker, a buzzer, a touch panel, and the like.

The mode switching button 20a is, for example, a button for switching between a driving assistance mode and a manual driving mode. The driving assistance mode is, for example, is a mode in which either or both of the traveling driving force output device 200 and the brake device 210, and the steering device 220 are controlled by the driving assistance control unit 100 when a steering wheel is being operated by the occupant. The manual driving mode is a mode in which the traveling driving force output device 200, the brake device 210, and the steering device 220 are controlled according to the amount of operation of the driving operator 80. Each device of the HMI 20 is attached to, for example, any part of an instrument panel or any place on a passenger seat, or a rear seat.

The vehicle sensor 30 includes, for example, a vehicle speed sensor that detects a speed of the subject vehicle M, an acceleration sensor that detects an acceleration, a yaw rate sensor that detects an angular velocity around a vertical axis, and an orientation sensor that detects a direction of the subject vehicle M.

The driving operator 80 includes, for example, an accelerator pedal, a brake pedal, a shift lever, a steering wheel, a turn indicator lever, and other operators. For example, an operation detection unit that detects the amount of operation is attached to each operator of the driving operator 80. The operation detection unit detects the amount of depression of the accelerator pedal or the brake pedal, a position of the shift lever, a steering angle of the steering wheel, and the like. The operation detection unit outputs a detection signal indicating the detected amount of operation of each operator to the driving assistance control unit 100, or one or both of the traveling driving force output device 200, the brake device 210, and the steering device 220.

For example, either or both of the grip detection sensor 80a and the steering torque detection sensor 80b are attached as the operation detection unit to the steering wheel. The grip detection sensor 80a outputs a predetermined detection signal to the driving assistance control unit 100 when the grip detection sensor 80a detects a weak current generated when the occupant touches the steering wheel. The steering torque detection sensor 80b detects the steering torque applied around a rotation shaft of the steering wheel. The steering torque detection sensor 80b detects the steering torque applied in a direction of a rotating shaft (shaft) of the steering wheel, and outputs a predetermined detection signal to the driving assistance control unit 100 when the detected steering torque becomes equal to or greater than a threshold value.

In the following description, a state in which an operation (gripping) of the steering wheel of the occupant is detected on the basis of the detection signal output by the grip detection sensor 80a or the steering torque detection sensor 80b is referred to as a “hands ON state”, and a state in which the operation is not detected is referred to as a “hands OFF state”.

The traveling driving force output device 200, the brake device 210, and the steering device 220 will be described prior to description of the driving assistance control unit 100. The traveling driving force output device 200 outputs a traveling driving force (torque) for traveling of the subject vehicle M to the driving wheels. The traveling driving force output device 200 includes, for example, a combination with an internal combustion engine, an electric motor, a transmission, and the like, and a power ECU that controls these. The power ECU controls the above configuration according to information input from the driving assistance control unit 100 or information input from the driving operator 80.

The brake device 210 includes, for example, a brake caliper, a cylinder that transfers hydraulic pressure to the brake caliper, an electric motor that generates hydraulic pressure in the cylinder, and a brake ECU. The brake ECU controls the electric motor according to information input from the driving assistance control unit 100 or information input from the driving operator 80 so that a brake torque corresponding to a braking operation is output to each wheel. The brake device 210 may include a mechanism that transfers the hydraulic pressure generated by the operation of the brake pedal included in the driving operator 80 to the cylinder via a master cylinder as a backup. The brake device 210 is not limited to the configuration described above and may be an electronically controlled hydraulic brake device that controls the actuator according to information input from the driving assistance control unit 100 and transfers the hydraulic pressure of the master cylinder to the cylinder.

The steering device 220 includes, for example, a steering ECU and an electric motor.

The electric motor, for example, changes a direction of the steerable wheels by causing a force to act on a rack and pinion mechanism. The steering ECU drives the electric motor according to information input from the driving assistance control unit 100 or information input from the driving operator 80 to change the direction of the steerable wheels.

The driving assistance control unit 100 includes, for example, a first control unit (first controller) 120, a second control unit (second controller) 140, and a switching control unit (switching controller) 150. Some or all of the components of the first control unit 120, the second control unit 140, and the switching control unit 150 may be realized by a processor such as a central processing unit (CPU) and a graphics processing unit (GPU) executing a program (software). Some or all of the components of the first control unit 120, the second control unit 140, and the switching control unit 150 may be realized by hardware such as a large scale integration (LSI), an application specific integrated circuit (ASIC), or a field-programmable gate array (FPGA), or may be realized by cooperation of the software and the hardware. The program may be stored in a storage device such as a hard disk drive (HDD) or a flash memory in advance or, the program may be stored in a detachable storage medium such as a DVD or a CD-ROM, the storage medium may be mounted on a drive device, and the program may be installed in the storage device.

The first control unit 120 includes, for example, an external world recognition unit (external world recognizer) 121 and a subject vehicle position recognition unit (subject vehicle position recognizer) 122. The external-world recognition unit 121 and the subject-vehicle position recognition unit 122 operate, for example, in both the driving assistance mode and the manual driving mode.

The external-world recognition unit 121 recognizes a state such as a position, a speed, or acceleration of a nearby vehicle on the basis of the information input from the camera 10, the radar 12, and the finder 14 via the object recognition device 16. The position of the nearby vehicle may be represented by a representative point such as a centroid or a corner of the nearby vehicle or may be represented by a region represented by an outline of the nearby vehicle. The “state” of the nearby vehicle may include an acceleration, a jerk, or a “state of action” (for example, whether the nearby vehicle is changing lane or trying to change lane) of the nearby vehicle. In addition to the nearby vehicle, the external-world recognition unit 121 may recognize positions of other types of objects, such as a guardrail, a utility pole, a parked vehicle, and a pedestrian.

The subject-vehicle position recognition unit 122 recognizes, for example, a lane (traveling lane) on which the subject vehicle M is traveling and a relative position and posture of the subject vehicle M relative to the traveling lane. The subject-vehicle position recognition unit 122, for example, recognizes lane markers LM of a road in the image captured by the camera 10 and recognizes, as a traveling lane, a lane demarcated by the two lane markers LM closest to the subject vehicle M among the recognized lane markers LM. The subject-vehicle position recognition unit 122 recognizes the position and posture of the subject vehicle M with respect to the recognized traveling lane.

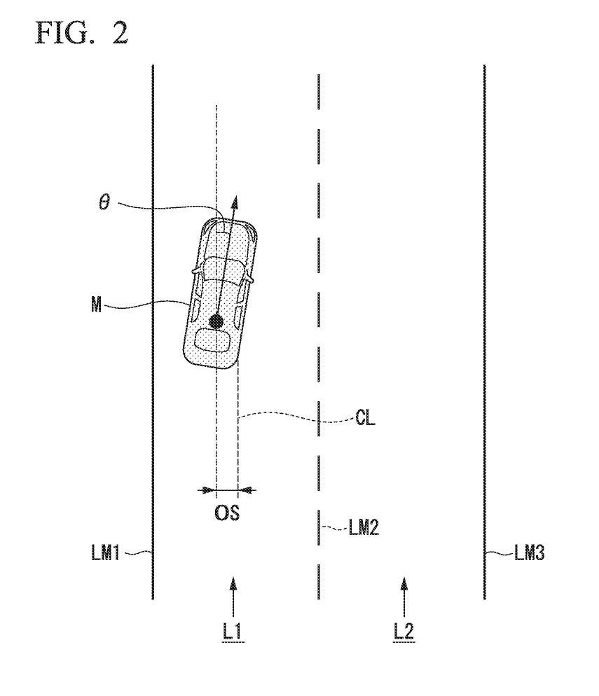

FIG. 2 is a diagram illustrating a state in which the relative position and posture of the subject vehicle M relative to a traveling lane L1 are recognized by the subject-vehicle position recognition unit 122. For example, the subject-vehicle position recognition unit 122 may recognize the lane markers LM1 to LM3 and recognize a region between the lane markers LM1 and LM2 closest to the subject vehicle M as a traveling lane L1 of the subject vehicle M. The subject-vehicle position recognition unit 122, for example, recognizes a deviation OS of a reference point (for example, a centroid) of the subject vehicle M from a traveling lane center CL and an angle θ of a travel direction of the subject vehicle M with respect to a line connecting the traveling lane centers CL as the relative position and the posture of the subject vehicle M relative to the traveling lane L1. Alternatively, the subject-vehicle position recognition unit 122 may recognize, for example, a position of the reference point of the subject vehicle M relative to any one of side end portions of the traveling lane L1 as a relative position of the subject vehicle M relative to the traveling lane.

The subject-vehicle position recognition unit 122 may derive an index value (hereinafter referred to as a reliability) indicating an accuracy of the recognized lane marker LM, in addition to the recognition of the lane marker LM. For example, the subject-vehicle position recognition unit 122 derives the reliability from a large feature amount (a density) of lane markers LM disposed on a line on the captured image of the camera 10 or parallelism of lines extracted as the lane markers LM, as a numerical value, and outputs the reliability value to the second control unit 140 or the switching control unit 150. The second control unit 140 or the switching control unit 150 receives the reliability value and determines accuracy of the recognition result of the subject-vehicle position recognition unit 122.

The second control unit 140 includes, for example, a speed assistance control unit (speed assistance controller) 141 and a steering assistance control unit (steering assistance controller) 142. The speed assistance control unit 141 and the steering assistance control unit 142, for example, operate in the driving assistance mode and stop in the manual driving mode.

The speed assistance control unit 141 controls the traveling driving force output device 200 and the brake device 210 such that speed control of the subject vehicle M is performed. For example, the speed assistance control unit 141 may accelerate or decelerate the subject vehicle M in a range of predetermined set vehicle speeds such that the subject vehicle M follows a nearby vehicle (a preceding vehicle) present in front of the subject vehicle M among the nearby vehicles recognized by the external world recognition unit 121. When a preceding vehicle is not recognized by the external-world recognition unit 121, the speed assistance control unit 141 accelerates or decelerates the subject vehicle M at the set vehicle speed.

The steering assistance control unit 142 controls the steering device 220 to perform steering control of the subject vehicle M. For example, the steering assistance control unit 142 controls steering of the subject vehicle M to keep the traveling lane center recognized by the subject-vehicle position recognition unit 122. For example, the steering assistance control unit 142 controls steering of the subject vehicle M so that each of the two lane markers LM demarcating the traveling lane and the subject vehicle M becomes equidistant. In the following description, the steering control for keeping the traveling lane center will be referred to as “lane keeping control”.

When the subject vehicle is traveling at a position deviated to either the left or the right from the traveling lane center, the steering assistance control unit 142 controls the steering so that the subject vehicle M returns to the traveling lane center to prevent the subject vehicle M from deviating from the traveling lane. More specifically, the steering assistance control unit 142 causes the HMI 20 to display a predetermined image when the distance between the lane marker LM demarcating the traveling lane and the subject vehicle M becomes equal to or smaller than the predetermined distance, and vibrates the steering wheel to request the occupant to pay attention. When there is no operation of the occupant with respect to the steering wheel after the steering wheel is vibrated, the steering assistance control unit 142 controls the steering device 220 to change the direction of the steerable wheels to the center of the lane and control steering so that the subject vehicle M returns to the center of the lane. In the following description, steering control for preventing deviation of the traveling lane is referred to as “out-of-road deviation prevention control”. The lane keeping control and the out-of-road deviation prevention control are examples of the “first steering control”.

When the lane marker LM is not recognized by the subject-vehicle position recognition unit 122 or when the reliability of the lane marker LM is equal to or smaller than the threshold value while the lane keeping control or the out-of-road deviation prevention control is being executed, the steering assistance control unit 142 limits (stops) the control that is being executed and performs the second steering control. In the second steering control in the first embodiment, the target steering angle θ_{TGT} is determined in a range of predetermined angles with reference to the steering angle when the subject vehicle M travels straight (hereinafter referred to as a reference steering angle θ_{REF}), and the steering of the subject vehicle M is controlled with the determined target steering angle θ_{TGT}. For example, when the reference steering angle θ_{REF} is 0 [°], the steering assistance control unit 142 determines the target steering angle in a range of angles of about ±5 [°] with reference to 0 [°] and controls the steering device 220 so that the current steering angle approaches the target steering angle θ_{TGT}.

The switching control unit 150 switches between the driving assistance mode and the manual driving mode according to an operation with respect to the mode switching button 20a. For example, the switching control unit 150 switches from the manual driving mode to the driving assistance mode in the hands-on state. The switching control unit 150 may switch from the driving assistance mode to the manual driving mode when the hands-off state continues for a predetermined time or longer in the driving assistance mode. In this case, the switching control unit 150 may report that the driving mode is to be switched to the occupant, using the HMI 20. In the manual driving mode, an input signal (a detection signal indicating the degree of amount of operation) from the driving operator 80 is output to the traveling driving force output device 200, the brake device 210, and the steering device 220. The input signal from the driving operator 80 may be output to the traveling driving force output device 200, the brake device 210, and the steering device 220 via the driving assistance control unit 100. Each of electronic control units (ECU) of the traveling driving force output device 200, the brake device 210, and the steering device 220 performs each operation on the basis of input signals from the driving operator 80 or the like.

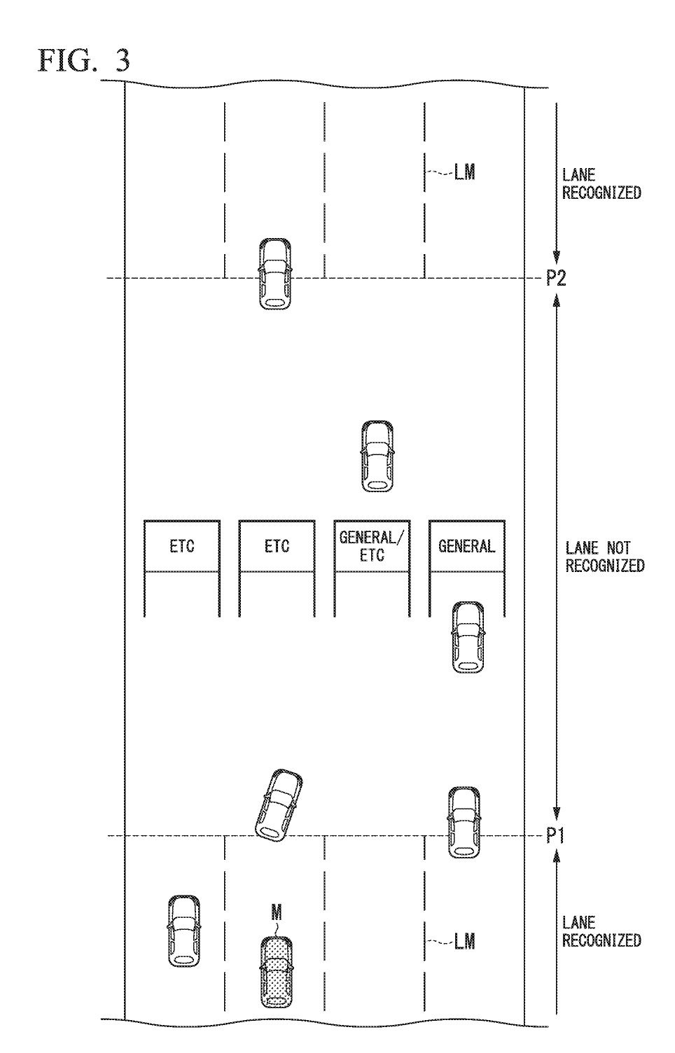

FIG. 3 is a diagram illustrating an example of a scene in which the lane marker LM is not recognized in the middle of the road. In the illustrated example, a scene when a vehicle passes through a tollgate on an expressway is shown. For example, in the vicinity of a tollgate, there is a section (a section from P1 to P2 in FIG. 3) in which lane markers of some or all of the lanes are not formed. For example, when the subject vehicle M approaches the point P1, the subject-vehicle position recognition unit 122 cannot recognize a traveling lane. In this case, when the steering assistance control unit 142 has executed the lane keeping control or the out-of-road deviation prevention control in a section before P1, the steering assistance control unit 142 stops this control and performs the second steering control.

When the subject vehicle M passes through the tollgate and approaches the point P2, the subject-vehicle position recognition unit 122 recognizes the traveling lanes again. In this case, the steering assistance control unit 142 stops the second steering control and restarts the lane keeping control or the out-of-road deviation prevention control on the basis of the lane markers LM recognized by the subject-vehicle position recognition unit 122.

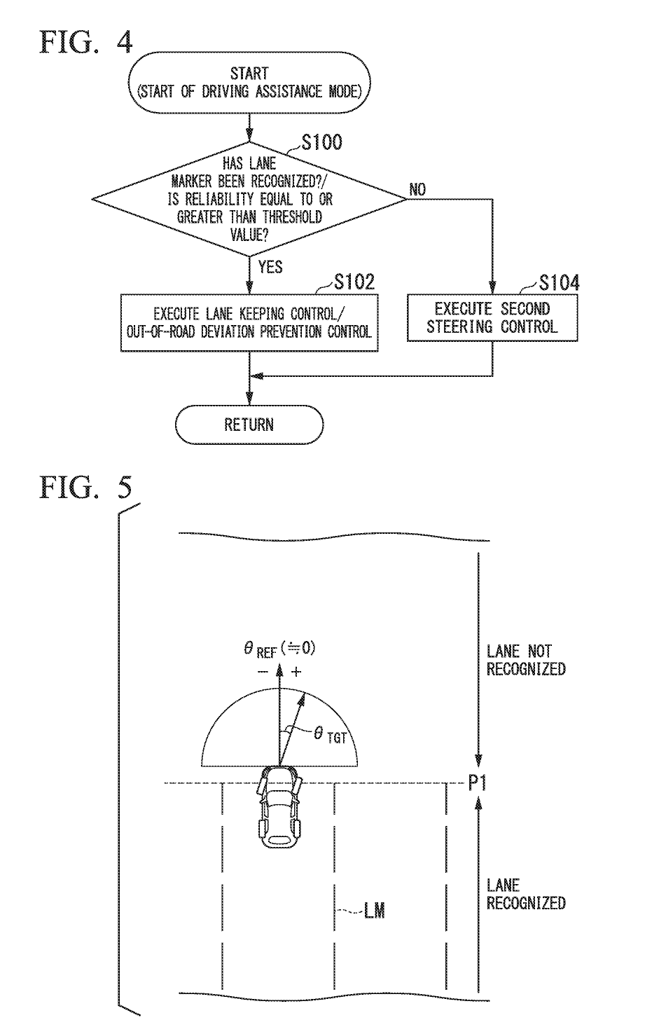

FIG. 4 is a flowchart illustrating a series of processes in the driving assistance control unit 100 in the first embodiment. For example, a process of this flowchart may be repeatedly performed in a predetermined cycle in the driving assistance mode.

First, the steering assistance control unit 142 determines whether the lane marker LM has been recognized by the subject-vehicle position recognition unit 122 or whether the reliability of the lane marker LM is equal to or greater than the threshold value (step S100).

For example, when the lane marker LM has been recognized by the subject-vehicle position recognition unit 122 or when the reliability of the lane marker LM is equal to or greater than the threshold value, the steering assistance control unit 142 stops the second steering control and performs lane keeping control or the out-of-road deviation prevention control on the basis of the recognized lane marker LM (step S102).

On the other hand, when the lane marker LM is not recognized by the subject-vehicle position recognition unit 122 or when the reliability of the lane marker LM is smaller than the threshold value, the steering assistance control unit 142 stops the lane keeping control or the out-of-road deviation prevention control and performs the second steering control (step S104). While the second steering control is being performed, the first control unit 120 continues various processes such as recognition of lane markers.

FIG. 5 is a diagram schematically illustrating a state of a behavior of the subject vehicle M according to the second steering control. For example, the steering assistance control unit 142 determines a steering angle at the time of switching from the lane keeping control or the out-of-road deviation prevention control to the second steering control, that is, an angle of a negative component for canceling out the target steering angle θ_{TGT} determined immediately before stopping the lane keeping control or the out-of-road deviation prevention control, as the target steering angle θ_{TGT} when the steering assistance control unit 142 performs the second steering control. Accordingly, a steering torque for causing a return from the current steering angle to the reference steering angle θ_{REF} is applied to the rotation shaft of the steering wheel, and the steering wheel moves to a neutral position at the time of traveling in a straight line.

Generally, when the vehicle control system 1 actively controls the steering of the subject vehicle M like the lane keeping control or the out-of-road deviation prevention control, an angle difference (slip angle) is generated between a direction of the steerable wheels (a rolling direction) and the traveling direction of the subject vehicle M, and a cornering force (a force in a direction orthogonal to a traveling direction of the subject vehicle M) and a lateral force (a force in a direction orthogonal to the direction of the steerable wheels) are generated in the steerable wheels. By receiving these forces, a self-aligning torque (a moment about a yaw axis) works on a vehicle body. In this case, when the steering control is stopped, the steerable wheels tend to return to the position of the reference steering angle θ_{REF} under the action of the self-aligning torque. However, since the self-aligning torque is naturally generated according to the direction of the steerable wheels and the traveling direction of the vehicle and is not controlled according to a predetermined amount of control, a change in the steering angle may not be continuous due to the self-aligning torque with respect to the change in the steering angle due to the steering control when the steering control is stopped, and it can be conceived that the occupant may sense omission of the steering torque (disappearance of the steering torque applied to the rotation shaft of the steering wheel) as an unease feeling.

On the other hand, when the lane markers LM are not recognized, the steering assistance control unit 142 does not immediately end the steering control, but performs the steering control using the target steering angle θ_{TGT} as the reference steering angle θ_{REF} at the time of traveling in a straight line to rotate the steering wheel for return to the position at the time of traveling in a straight line. Therefore, when the occupant grips the steering wheel, the wheel moves in the griping hand irrespective of an intention of the occupant. Thus, the occupant can perceive that the steering torque is not omitted. Thus, since the steering control of the subject vehicle M is continued while an active force is applied to the steering wheel unlike the self-aligning torque (passive force) which is also generated during manual driving, it is difficult for the occupant to feel switching of the control. As a result, it is possible to switch control more naturally.

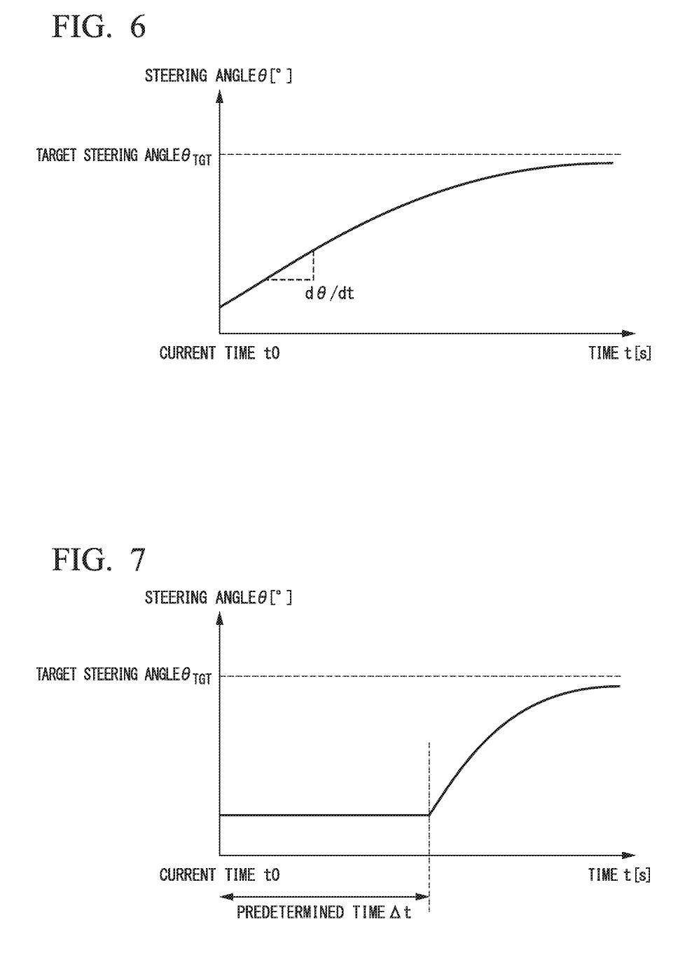

FIG. 6 is a diagram illustrating an example of a relationship between the steering angle θ and an elapsed time t. For example, when the steering assistance control unit 142 performs the second steering control, the steering assistance control unit 142 causes the steering angle θ at a current time t0 to approach the target steering angle θ_{TGT} according to the elapsed time t. In this case, the steering assistance control unit 142 limits the amount of change in the steering angle θ per a predetermined time dt that can be taken (dθ/dt) to curtail a sudden change in the steering angle. Accordingly, as illustrated in FIG. 6, the steering assistance control unit 142 causes an actual steering angle θ to gradually approach the target steering angle θ_{TGT}.

FIG. 7 is a diagram illustrating another example of the relationship between the steering angle θ and the elapsed time t. As illustrated in FIG. 7, for example, the steering assistance control unit 142 keeps the current steering angle θ until the predetermined time Δt elapses or until the vehicle travels a predetermined distance corresponding to the predetermined time Δt and causes the current steering angle θ to approach the target steering angle θ_{TGT} after a predetermined time Δt elapses (after the vehicle travels a predetermined distance).

According to the first embodiment described above, the subject-vehicle position recognition unit 122 that recognizes the lane markers of the road, and the steering assistance control unit 142 that performs the lane keeping control or the out-of-road deviation prevention control (an example of the first steering control) on the basis of the lane markers for demarcating the traveling lane on which the subject vehicle M travels among the lane markers recognized by the subject-vehicle position recognition unit 122 are included, and when the lane markers demarcating the traveling lane are not recognized by the subject-vehicle position recognition unit 122 in front of the subject vehicle M or when the reliability of the recognized lane markers is smaller than the threshold value, the steering assistance control unit 142 limits the lane keeping control or the out-of-road deviation prevention control, determines the target steering angle θ_{TGT} in the range of the predetermined angle with reference to the steering angle at the time of traveling in a straight line of the subject vehicle M, and performs the second steering control at the determined target steering angle θ_{TGT}, such that it is possible to switch the control more naturally since the steering control of the subject vehicle M is continued while causing the steering torque to act on the steering wheel.

According to the first embodiment described above, since the first control unit 120 also continues the process of recognizing the lane markers while the lane marker is not recognized (while the second steering control is being performed), automatic return to the lane keeping control or the out-of-road deviation prevention control (one example of the first steering control) can be caused to occur when the lane markers are recognized again. As a result, it is possible to reduce labor of causing the vehicle to return to a state in which the lane keeping control or the out-of-road deviation prevention control can be performed, for example, by the occupant operating a dedicated switch or the like.

According to the first embodiment described above, since the second steering control is performed in the vicinity of the tollgate of the expressway, and the second steering control is not performed on a general road in which there are many opportunities to simply steer, such as a right or left turn or a curve, it is possible to reduce unease feeling of the occupant caused by setting the target steering angle θ_{TGT} with reference to the steering angle at the time of traveling in a straight line.

According to the first embodiment described above, since the target steering angle θ_{TGT} is determined while limiting the amount of change of the steering angle θ that can be acquired per time, it is possible to curtail a sudden change in the steering angle and reduce the unease feeling of the occupant.

According to the first embodiment described above, since the current steering angle θ is kept until a predetermined time Δt elapses or until the vehicle travels a predetermined distance corresponding to the predetermined time Δt, and the current steering angle θ is caused to approach the target steering angle θ_{TGT} after the predetermined time Δt elapses or the vehicle travels the predetermined distance, a time until the subject vehicle M moves to the outside of the traveling lane can be made longer. As a result, it is possible to secure sufficient time to detect whether or not the occupant cannot grip the steering wheel.

In the embodiment described above, a case in which the steering assistance control unit 142 performs the second steering control when the lane marker LM is not recognized in the vicinity of the tollgate of the expressway has been described, but the present invention is not limited thereto. For example, the steering assistance control unit 142 may perform the second steering control when the lane marker LM is not recognized in a simple straight or curved route. For example, in a case in which the lane marker LM is not recognized when the subject vehicle M is traveling on a curved route, the steering assistance control unit 142 determines the target steering angle θ_{TGT} at the time of the second steering control on the basis of the target steering angle θ_{TGT} at the time of the steering control performed before the lane marker LM was not recognized.

### Second Embodiment

Hereinafter, a second embodiment will be described. The second embodiment is different from the first embodiment described above in that complicated control in which both speed control and steering control for lane changing or the like are combined is automatically performed, in addition to, for example, following control for following a preceding vehicle, the lane keeping control, and the out-of-road deviation prevention control described above. Hereinafter, differences between the second embodiment and the first embodiment will be mainly described, and description of the same functions or the like as in the first embodiment will be omitted.

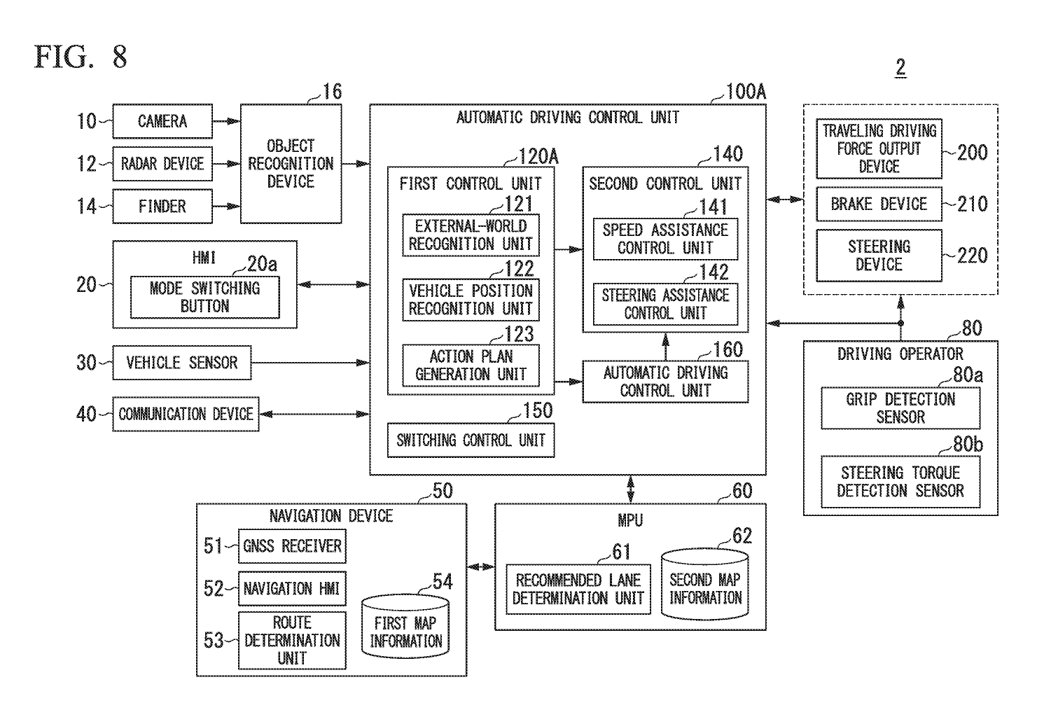

FIG. 8 is a configuration diagram of a vehicle control system 2 according to the second embodiment. The vehicle control system 2 according to the second embodiment includes, for example, a camera 10, a radar 12, a finder 14, an object recognition device (object recognizer) 16, an HMI 20, a vehicle sensor 30, a communication device (communicator) 40, a navigation device (navigator) 50, a map position unit (MPU) 60, a driving operator 80, an automatic driving control unit (automatic driving controller) 100A, a traveling driving force output device 200, a brake device 210, and a steering device 220. These apparatuses or devices are connected to each other by a multiplex communication line such as a CAN communication line, a serial communication line, a wireless communication network, or the like. The configuration illustrated in FIG. 8 is merely an example, and a part of the configuration may be omitted, or another configuration may be added.

The mode switching button 20a of the HMI 20 of the second embodiment is, for example, a button for switching to any one of the automatic driving mode, the driving assistance mode, and the manual driving mode. The automatic driving mode is a mode in which both the traveling driving force output device 200 and the brake device 210, and the steering device 220 are controlled by the automatic driving control unit 100A.

The communication device 40, for example, communicates with another vehicle present in the vicinity of the subject vehicle M using a cellular network, a Wi-Fi network, Bluetooth (registered trademark), dedicated short range communication (DSRC), or the like or communicate with various server devices via a wireless base station.

The navigation device 50 includes, for example, a global navigation satellite system (GNSS) receiver 51, a navigation HMI 52, and a route determination unit (route determiner) 53, and holds first map information 54 in a storage device such as a hard disk drive (HDD) or a flash memory. The GNSS receiver 51 identifies a position of the subject vehicle M on the basis of a signal received from the GNSS satellite. The position of the subject vehicle M may be specified or supplemented by an inertial navigation system (INS) using an output of the vehicle sensor 30. The navigation HMI 52 includes a display device, a speaker, a touch panel, keys, and the like. The navigation HMI 52 may be partly or wholly shared with the above-described HMI 20. The route determination unit 53, for example, determines a route from the position of the subject vehicle M (or any input position) specified by the GNSS receiver 51 to a destination input by the occupant using the navigation HMI 52 by referring to the first map information 54.

The first map information 54 is, for example, information in which a road shape is represented by a link indicating a road and a node connected by the link. The first map information 54 may include a curvature of the road, point of interest (POI) information, and the like. The route determined by the route determination unit 53 is output to the MPU 60. The navigation device 50 may perform route guidance using the navigation HMI 52 on the basis of the route determined by the route determination unit 53. The navigation device 50 may be realized by a function of a terminal device such as a smartphone or a tablet terminal possessed by the user, for example. The navigation device 50 may transmit a current position and a destination to a navigation server via the communication device 40 and acquire a route returned from the navigation server.

The MPU 60, for example, functions as a recommended lane determination unit (recommended lane determiner) 61, and holds second map information 62 in a storage device such as an HDD or a flash memory. The recommended lane determination unit 61 divides the route provided from the navigation device 50 into a plurality of blocks (for example, divides the route every 100 [m] in a traveling direction of the vehicle), and determines a recommended lane by referring to the second map information 62. The recommended lane determination unit 61 performs a process of determining the recommended lane as a number of lanes from the left. The recommended lane determination unit 61 determines the recommended lane so that the subject vehicle M can travel on a reasonable route for traveling to a branch destination when there are branching points, merging points, or the like in the route.

The second map information 62 is map information with higher accuracy than the first map information 54. The second map information 62 includes, for example, information on a center of the lane or information on a boundary of the lane. The second map information 62 may include road information, traffic regulations information, address information (address and zip code), facility information, telephone number information, and the like. The road information includes information indicating types of roads such as expressways, toll roads, national expressways, and prefectural roads, or information such as a reference speed of the road, the number of lanes, a width of each lane, a gradient of road, a position (three-dimensional coordinates including longitude, latitude, and height) of the road, a curvature of curves of the road or each lane of the road, positions of merging and branching points of a lane, and signs provided on the road. The reference speed is, for example, a legal speed or an average speed of a plurality of vehicles traveling the road in the past. The second map information 62 may be updated at any time by accessing another device using the communication device 40.

The automatic driving control unit 100A includes, for example, a first control unit 120A, a second control unit 140, a switching control unit 150, and an automatic driving controller 160. Some or all of these components are realized by a processor such as a CPU executing a program (software). Some or all of the above components may be realized by hardware such as an LSI, an ASIC or an FPGA or may be realized by cooperation of software and hardware.

The first control unit 120 includes, for example, the external-world recognition unit 121 and the subject-vehicle position recognition unit 122 described above, and an action plan generation unit (action plan generator) 123.

The subject-vehicle position recognition unit 122 in the second embodiment, for example, compares a pattern of a road lane marker (for example, an arrangement of solid lines and broken lines) obtained from the second map information 62 with a pattern of the road lane maker in the vicinity of the subject vehicle M recognized in the image captured by the camera 10 to recognize the traveling lane. In this recognition, the position of the subject vehicle M acquired from the navigation device 50 or a processing result of INS may be added. The subject-vehicle position recognition unit 122 recognizes, for example, the position or posture of the subject vehicle M with respect to the traveling lane. The relative position of the subject vehicle M recognized by the subject-vehicle position recognition unit 122 is provided (output) to the recommended lane determination unit 61 and the action plan generation unit 123.

The action plan generation unit 123, for example, determines events to be sequentially executed in the automatic driving so that the subject vehicle M travels along a recommended lane determined by the recommended lane determination unit 61 and so that the subject vehicle M can cope with surrounding situations of the subject vehicle M. The events are information that define a traveling aspect of the subject vehicle M. The events include, for example, a constant-speed traveling event in which a vehicle travels on the same traveling lane at a constant speed, a lane changing event in which a traveling lane of the subject vehicle M is changed, an overtaking event in which the subject vehicle M overtakes a preceding vehicle, a following traveling event in which the subject vehicle M travels following a preceding vehicle, a merging event in which the subject vehicle M merges from a branch line to a main line at a merging point, a branching event in which the subject vehicle M is caused to travel on a target lane at a branching point of the road, an emergency stopping event in which the subject vehicle M is caused to make an emergency stop, and a switching event in which automatic driving is ended and switching to manual driving is performed. An event for avoidance may be planned on the basis of the surrounding situation of the subject vehicle M (presence of nearby vehicles or pedestrians, lane narrowing due to road construction, or the like) during execution of these events.

The action plan generation unit 123 generates the target trajectory when the subject vehicle M travels on the route determined by the route determination unit 53 in the future on the basis of the determined events (a set of a plurality of events planned according to the route). The target trajectory is expressed by arranging points (trajectory points) that the subject vehicle M will reach in an order. The trajectory points are points that the subject vehicle M will reach at each of predetermined travel distances. Separately, a target speed at each predetermined period of sampling time (for example, about every one tenth [sec]) is determined as a part (one element) of the target trajectory. The target speed may include an element such as a target acceleration or a target jerk. The trajectory point may be a position that the subject vehicle M will reach at sampling times in every predetermined period of sampling time. In this case, the target speed is determined using an interval of the trajectory points.

For example, the action plan generation unit 123 determine the target speed when the subject vehicle M is caused to travel along the target trajectory, on the basis of the reference speed (for example, the legal speed) preset on the route to the destination or a relative speed with respect to a nearby vehicle at the time of traveling. The action plan generation unit 123 determines the curvature of the target trajectory (the degree of the curve of the trajectory) on the basis of the positional relationship between the trajectory points. The action plan generation unit 123 outputs the target trajectory of which the target speed and the curvature have been determined to the automatic driving controller 160.

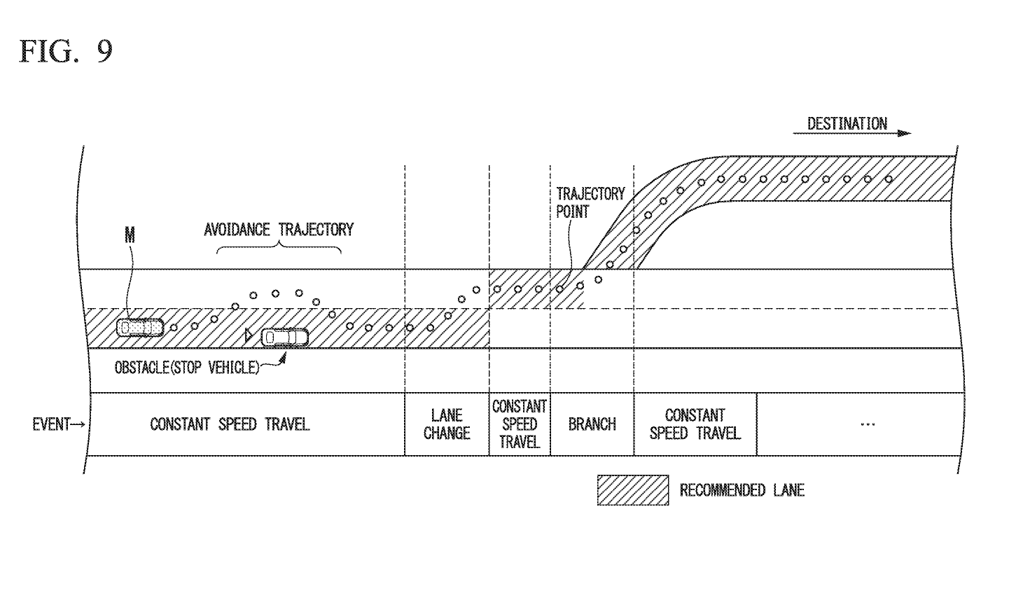

FIG. 9 is a diagram illustrating a state in which the target trajectory is generated on the basis of the recommended lane. As illustrated in FIG. 9, the recommended lane is set to be convenient for traveling along the route to the destination.

When the recommended lane is determined, the action plan generation unit 123 activates a lane change event, a branch event, a merging event or the like when the subject vehicle approaches a predetermined distance before a switching point of the recommended lane (which may be determined according to a type of event). When it becomes necessary to avoid an obstacle OB during execution of each event, an avoidance trajectory is generated as illustrated in FIG. 9.

The switching control unit 150 switches a driving mode to any one of the automatic driving mode, the driving assistance mode, and the manual driving mode according to the operation with respect to the mode switching button 20a. The switching control unit 150 switches the driving mode from another driving mode to the automatic driving mode at a scheduled start point of the automatic driving. The switching control unit 150 switches the driving mode from the automatic driving mode to another driving mode at a scheduled end point of automatic driving (for example, a destination).

The switching control unit 150 may switch the driving mode from the automatic driving mode to the manual driving mode on the basis of the detection signal input from the driving operator 80. For example, when the amount of operation indicated by the detection signal exceeds a threshold value, that is, when the driving operator 80 receives an operation from the occupant with an amount of operation exceeding the threshold value, the switching control unit 150 switches the driving mode from the automatic driving mode to the manual driving mode. For example, in the case in which the driving mode is set to the automatic driving mode, when the steering wheel and the accelerator pedal or the brake pedal are operated by the occupant with an amount of operation exceeding the threshold value, the switching control unit 150 switches the driving mode from the automatic driving mode to the manual driving mode.

The automatic driving controller 160, for example, operates in the automatic driving mode and stops the operation in the other modes. For example, the automatic driving controller 160 controls the traveling driving force output device 200, the brake device 210, and the steering device 220 such that the subject vehicle M passes through the target trajectory generated by the action plan generation unit 123 at a scheduled time. In the following description, controlling the traveling driving force output device 200, the brake device 210, and the steering device 220 on the basis of the target trajectory is referred to as “automatic driving control”.

For example, the automatic driving controller 160 controls the traveling driving force output device 200 and the brake device 210 according to a target speed included in the target trajectory. The automatic driving controller 160 determines the target steering angle θ_{TGT} on the basis of a curvature of the target trajectory and controls the steering device 220 on the basis of the determined target steering angle θ_{TGT}.

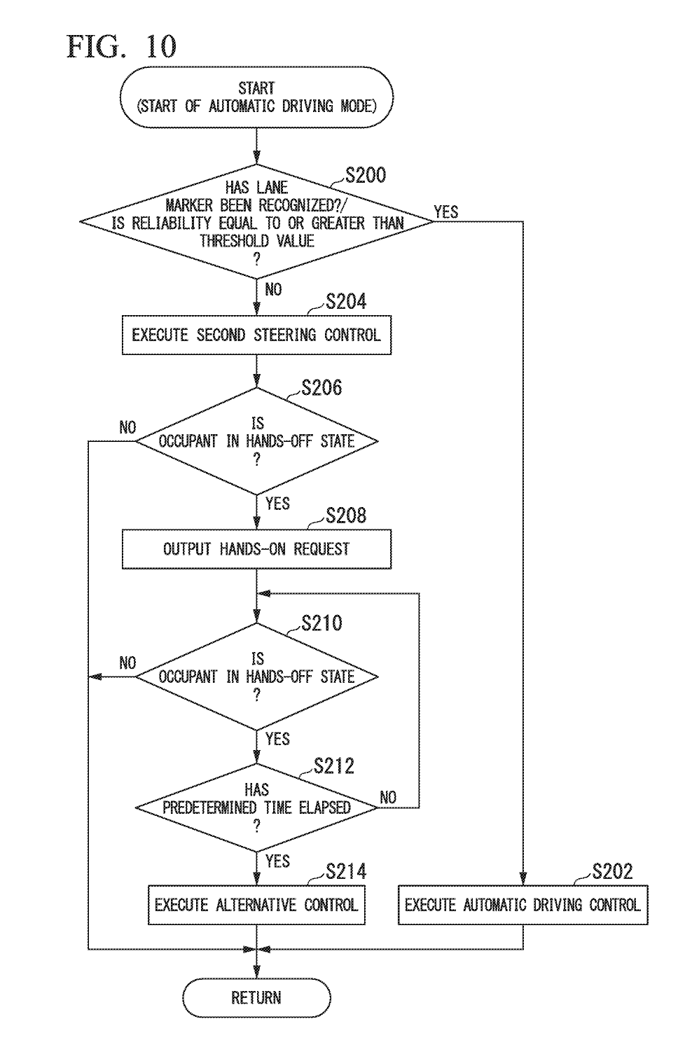

FIG. 10 is a flowchart illustrating a series of processes in the automatic driving control unit 100A in the second embodiment. For example, a process of this flowchart may be repeatedly performed at a predetermined cycle in the automatic driving mode.

First, the action plan generation unit 123 determines whether or the lane marker LM has been recognized by the subject-vehicle position recognition unit 122 or whether the reliability of the lane marker LM is equal to or greater than the threshold value (step S200).

For example, when the lane marker LM is recognized by the subject-vehicle position recognition unit 122 or when the reliability of the lane marker LM is equal to or greater than the threshold value, the action plan generation unit 123 generates the target trajectory. The automatic driving controller 160 receives the target trajectory and performs automatic driving control on the basis of the target trajectory (step S202).

On the other hand, when the lane marker LM is not recognized by the subject-vehicle position recognition unit 122 or when the reliability of the lane marker LM is smaller than the threshold value, the switching control unit 150 switches the driving mode from the automatic driving mode to the driving assistance mode in which hands-on is necessary. Then, the automatic driving controller 160 receives the target trajectory, stops the automatic driving control on the basis of the target trajectory, and instructs the steering assistance control unit 142 to perform the second steering control (step S204).

Next, the automatic driving controller 160 determines whether the occupant is in the hands-off state or the hands-on state on the basis of the detection signal output by the grip detection sensor 80a or the steering torque detection sensor 80b (step S206).

When the occupant is in the hands-on state, the automatic driving controller 160 ends the process of this flowchart while causing the steering assistance control unit 142 to continue the second steering control.

On the other hand, when the occupant is in the hands-off state, the automatic driving controller 160 outputs information for requesting hands-on (information for requesting the occupant to grip the steering wheel) using the HMI 20 (step S208).

Then, the automatic driving controller 160 determines whether the occupant is in the hands-off state or the hands-on state on the basis of the detection signal output by the grip detection sensor 80a or the steering torque detection sensor 80b (step S210).

When the occupant is in the hands-off state, the automatic driving controller 160 determines whether or not a predetermined time has elapsed after hands-on has been requested (step S212). When the predetermined time has not elapsed, the automatic driving controller 160 continues the determination of the hands-off state.

When the occupant enters a hands-on state within a predetermined time, the automatic driving controller 160 ends the process of this flowchart while causing the steering assistance control unit 142 to continue the second steering control.

On the other hand, when the passenger does not enter the hands-on state within the predetermined time, the automatic driving controller 160 performs alternative control instead of the second steering control (step S214). For example, when the occupant does not enter the hands-on state within the predetermined time, the action plan generation unit 123 generates a target trajectory for decelerating the subject vehicle M and stopping the vehicle. The automatic driving controller 160 receives the target trajectory and performs deceleration control. Accordingly, the process of this flowchart ends.

In the process of S204 described above, the automatic driving controller 160 may performs automatic driving control for requiring hands-on as the control corresponding to the second steering control instead of instructing the steering assistance control unit 142 to perform the second steering control. For example, when the lane marker LM is not recognized by the subject-vehicle position recognition unit 122 or when the reliability of the lane marker LM is smaller than the threshold value, the action plan generation unit 123 determines the curvature of the target trajectory on the basis of a predetermined angle with reference to the reference steering angle θ_{REF} at the time of traveling in a straight line of the subject vehicle M. More specifically, the action plan generation unit 123 generates the target trajectory of which the curvature is zero or several percent that is regarded as zero, which extends in a direction (orientation) indicated by the reference steering angle θ_{REF}. In this case, when the target trajectory extends in a direction indicated by an angle deviated from the reference steering angle θ_{REF} (one angle within a predetermined angle), the action plan generation unit 123 may determine the curvature of the target trajectory so that the target trajectory curves in a direction indicated by the reference steering angle θ_{REF} from that direction. That is, the action plan generation unit 123 determines the curvature of the target trajectory according to an angle difference between an angle determined as an extending direction of the target trajectory and the reference steering angle θ_{REF}. The automatic driving controller 160 determines the target steering angle θ_{TGT} on the basis of the curvature of the target trajectory and performs automatic driving control corresponding to the second steering control according to the determined target steering angle θ_{TGT}. When the automatic driving controller 160 does not instruct the steering assistance control unit 142 to perform the second steering control, the switching control unit 150 continuously keeps the automatic driving mode.

According to the second embodiment described above, since the automatic driving controller 160 performs the automatic driving control in which hands-on is not required when the lane marker demarcating the traveling lane is recognized or when the reliability is equal to or greater than the threshold value, and limits the automatic driving control and causes the steering assistance control unit 142 to perform the second steering control or performs automatic driving control in which hands-on is required when the lane marker demarcating the traveling lane is not recognized or when the reliability is smaller than the threshold value, it is possible to continue steering control of the subject vehicle M while causing the steering torque to act on the steering wheel. As a result, it is possible to switch the control more naturally, as in the first embodiment described above.

According to the second embodiment described above, since the second steering control is performed when the occupant is at least touching the steering wheel, the occupant can rapidly perform steering. As a result, it is possible to prevent steering control not intended by the occupant from being performed.

According to the second embodiment described above, since the subject vehicle M is caused to travel straight as the second steering control when the lane marker is not recognized, it is possible to further extend a time until the subject vehicle M moves to the outside of the traveling lane. As a result, it is possible to secure sufficient time to detect whether or not the occupant cannot grip the steering wheel.

According to the second embodiment described above, since the occupant is requested to operate the steering wheel according to the hands-on request and the straight travel control is performed until the steering control is performed according to the operation of the steering wheel of the occupant, it is possible to continue the control even when the reliability of the recognized lane marker is smaller than the threshold value.

According to the second embodiment described above, when the occupant does not operate the steering wheel for a predetermined time after hands-on has been requested, the subject vehicle M is decelerated and stopped. Thus, when the occupant cannot perform the steering control manually or when there is no intention of steering control, it is possible to limit the continuation of vehicle traveling not intended by the occupant.

According to the second embodiment described above, when the lane marker LM is not recognized by the subject-vehicle position recognition unit 122 or when the reliability of the lane marker LM is smaller than the threshold value, the automatic driving mode is continued without switching to the driving assistance mode and the action plan generation unit 123 is caused to generate the target trajectory of which the curvature is zero or several percent that is regarded as zero. Thus, it is possible to set the target steering angle θ_{TGT} to zero or several percent that is regarded as zero. Accordingly, it is possible to continue the steering control of the subject vehicle M while causing the steering torque to act on the steering wheel without switching from the automatic driving control in the automatic driving mode to the second steering control in the driving assistance mode. As a result, it is possible to switch the control more naturally, as in the first embodiment described above.

The above-described embodiment can be represented as follows.

A vehicle control system includes a storage for storing a program, and a processor, and the processor executes the program to recognize lane markers on a road, perform first steering control so that the subject vehicle does not deviate from a traveling lane on which the subject vehicle travels on the basis of a lane marker demarcating the traveling lane among the recognized lane markers, and to limit the first steering control, determine a target steering angle in a range of predetermined angles with reference to a steering angle at the time of traveling in a straight line of the subject vehicle, and perform second steering control at the determined target steering angle when the lane marker demarcating the traveling lane is not recognized in front of the subject vehicle or when an index value indicating a degree of recognition of the lane marker is smaller than a threshold value.

Although modes for carrying out the present invention have been described above using embodiments, the present invention is not limited to these embodiments at all, and various modifications and substitutions may be made without departing from the spirit of the present invention.

What is claimed is:

1. A vehicle control system, comprising:
a recognition unit that recognizes lane markers on a road; and
a steering control unit that performs first steering control so that a subject vehicle does not deviate from a traveling lane on which the subject vehicle travels on the basis of a lane marker demarcating the traveling lane among the lane markers recognized by the recognition unit,
wherein when a lane marker demarcating the traveling lane is not recognized by the recognition unit in front of the subject vehicle or when an index value indicating a degree of recognition of the lane marker is smaller than a threshold value, the steering control unit,
limits the first steering control,
determines a target steering angle in a range of predetermined angles with reference to a steering angle at the time of traveling in a straight line of the subject vehicle, and
performs second steering control at the determined target steering angle.

2. The vehicle control system according to claim 1, wherein when return from a state in which a lane marker demarcating the traveling lane is not recognized to a state in which the lane marker is recognized occurs or when return from a state in which the index value is smaller than the threshold value to a state in which the index value is equal to or greater than the threshold value occurs, the steering control unit limits the second steering control and performs the first steering control.

3. The vehicle control system according to claim 1, wherein the steering control unit performs the second steering control when the subject vehicle is traveling on an expressway.

4. The vehicle control system according to claim 1, further comprising an operation detection unit that detects that a driving operator is operated by an occupant of the subject vehicle,
wherein the steering control unit performs the second steering control when an operation of the driving operator is detected by the operation detection unit.

5. The vehicle control system according to claim 4, further comprising a report unit that reports predetermined information for requesting an occupant of the subject vehicle to operate the driving operator when a lane marker demarcating the traveling lane is not recognized in front of the subject vehicle by the recognition unit or when the index value is smaller than the threshold value,
wherein the steering control unit
continues the second steering control until a predetermined time elapses after the report unit reports the predetermined information, and
limits the second steering control when the operation of the driving operator is not detected within a predetermined time by the operation detection unit.

6. The vehicle control system according to claim 1, further comprising a speed control unit that performs deceleration control for decelerating the subject vehicle when the second steering control is limited by the steering control unit.

7. The vehicle control system according to claim 1, further comprising an automatic driving control unit that performs automatic driving control for automatically controlling steering and acceleration or deceleration of the subject vehicle,
wherein the automatic driving control unit performs the automatic driving control in which it is not required that a driving operator is gripped by an occupant of the subject vehicle when the lane marker demarcating the traveling lane is recognized by the recognition unit or when the index value is equal to or greater than the threshold value, and
limits the automatic driving control and causes the steering control unit to perform the second steering control when the lane marker demarcating the traveling lane is not recognized by the recognition unit or when the index value is smaller than the threshold value.

8. The vehicle control system according to claim 1, further comprising:
an operation detection unit that detects that a driving operator is operated by an occupant of the subject vehicle; and
an automatic driving control unit that performs automatic driving control for automatically controlling steering and acceleration or deceleration of the subject vehicle,
wherein the automatic driving control unit performs the automatic driving control in which it is not required that a driving operator is gripped by an occupant of the subject vehicle when the lane marker demarcating the traveling lane is recognized by the recognition unit or when the index value is equal to or greater than the threshold value, and
performs automatic driving control in which it is required that the driving operator is gripped by the occupant of the subject vehicle when the lane marker demarcating the traveling lane is not recognized by the recognition unit or when the index value is smaller than the threshold value, and when the operation of the driving operator is not detected by the operation detection unit.

9. A vehicle control system, comprising:
a recognition unit that recognizes lane markers on a road;
a generation unit that generates a target trajectory on the basis of a lane marker demarcating a traveling lane on which a subject vehicle travels among the lane markers recognized by the recognition unit; and
a steering control unit that determines a target steering angle on the basis of a curvature of the target trajectory generated by the generation unit and performs steering control on the basis of the determined target steering angle,
wherein the generation unit determines the curvature of the target trajectory on the basis of a predetermined angle with reference to a steering angle at the time of traveling in a straight line of the vehicle when the lane marker demarcating the lane is not recognized in front of the subject vehicle by the recognition unit or when an index value indicating a degree of recognition of the lane marker is smaller than a threshold value.

10. The vehicle control system according to claim 9, wherein the steering control unit causes a current steering angle to approach the target steering angle while limiting the amount of change in the steering angle per a predetermined time when the lane marker demarcating the traveling lane is not recognized or when the index value is smaller than the threshold value.

11. The vehicle control system according to claim 9, wherein when the lane marker demarcating the traveling lane is not recognized or when the index value is smaller than the threshold value, the steering control unit keeps a current steering angle until a predetermined time elapses or until a subject vehicle travels a predetermined distance and causes the current steering angle to approach the target steering angle after the predetermined time elapses or after the subject vehicle travels the predetermined distance.

12. A vehicle control method which is performed by a vehicle-mounted computer, the method comprising:
recognizing lane markers on a road;
performing first steering control so that the subject vehicle does not deviate from a traveling lane on which the subject vehicle travels on the basis of a lane marker demarcating the traveling lane among the recognized lane markers;
limiting the first steering control and determining a target steering angle in a range of predetermined angles with reference to a steering angle at the time of traveling in a straight line of the subject vehicle when the lane marker demarcating the traveling lane is not recognized in front of the subject vehicle or when an index value indicating a degree of recognition of the lane marker is smaller than a threshold value; and
performing second steering control at the determined target steering angle.

13. A storage medium storing a vehicle control program, the vehicle control program causing a vehicle-mounted computer to:
recognize lane markers on a road,
perform first steering control so that the subject vehicle does not deviate from a traveling lane on which a subject vehicle travels on the basis of a lane marker demarcating the traveling lane among the recognized lane markers,
limit the first steering control and determine a target steering angle in a range of predetermined angles with reference to a steering angle at the time of traveling in a straight line of the subject vehicle when the lane marker demarcating the traveling lane is not recognized in front of the subject vehicle or when an index value indicating a degree of recognition of the lane marker is smaller than a threshold value, and
perform second steering control at the determined target steering angle.
